(19) United States
(12) Patent Application Publication
(10) Pub. No.: US 2021/0264375 A1
(43) Pub. Date: Aug. 26, 2021

(54) TIME SERIES DATA PREDICTION APPARATUS AND TIME SERIES DATA PREDICTION METHOD

(71) Applicant: HITACHI, LTD., Tokyo (JP)

(72) Inventors: Yosuke HIMURA, Tokyo (JP); Mineyoshi MASUDA, Tokyo (JP)

(73) Assignee: HITACHI, LTD., Tokyo (JP)

(21) Appl. No.: 17/009,204

(22) Filed: Sep. 1, 2020

(30) Foreign Application Priority Data
Feb. 25, 2020 (JP) 2020-029523

(51) Int. Cl. G06Q 10/10; G06Q 10/04; G06N 5/00; G06N 7/00

(52) U.S. Cl. CPC G06Q 10/1093; G06N 7/005; G06N 5/003; G06Q 10/04

(57) ABSTRACT

Prediction of time series data can be performed while coping with a “non-equidistant event,” “extrapolation,” and a “base line shift.” An event regression section calculates event prediction data that is predicted values of metric data in an intended period including a past certain period on the basis of actual measured value data indicating values of the metric data in the past metric data. A correction section calculates, as prediction result data that is a prediction result of the time series data, data obtained by shifting each value of the event prediction data in response to a difference between the actual measured value data and the event prediction data in a same period.

### BACKGROUND OF THE INVENTION

### 1. Field of the Invention

The present disclosure relates to a technology for predicting time series data.

### 2. Description of the Related Art

In an information system including various apparatuses such as a server and a storage device, various time series data referred to as metric data is measured, and to appropriately predict future values of the metric data is effective in management work such as capacity planning.

In predicting the metric data, it is important to take into account three requirements as follows.

A first requirement is that metric data often has a large fluctuation at non-equidistant timing such as a specific day of week near the end of the month. In the present specification, such a large fluctuation occurring on the metric data at the non-equidistant timing is referred to as a “non-equidistant event.”

A second requirement is that a value not measured in the past often occurs in the future. In general, to predict the value not measured in the past is referred to as “extrapolation.”

A third requirement is that a relative behavior of the metric data continues before and after specific timing such as timing of a change of the month, but an absolute value range often has a large shift. In the present specification, such a shift is referred to as a “base line shift.”

Furthermore, as a method of predicting metric data, there is known a method of analyzing past metric data (for example, metric data in last few months) and predicting future metric data (for example, metric data in next few months). Since the metric data is normally large in number, it is difficult to manually perform such a method. For this reason, an approach such as machine learning is used for prediction of metric data.

As a machine learning approach for predicting metric data in consideration of “non-equidistant events,” tree-based (for example, decision tree-based and regression tree-based) approaches capable of handling a behavior in response to a date, a day of week, and the like are prominent. The tree-based approaches include RANDOM FORESTS® and the like.

However, with the tree-based approaches, it is difficult to cope with “extrapolation” and “base line shift.”

To address such a problem, JP-2017-123088-A discloses a technology for selecting feature variables using data in a last long period and then narrowing down the feature variables using most recent data, using a decision tree learning algorithm of a tree-based approach, in order to cope with a most recent change of a tendency in training data.

With the technology described in JP-2017-123088-A, the training data used to create (learn) a final prediction model is considered to be only most recent data and, therefore, may be capable of coping with the “base line shift” occurring immediately afterward. However, with the technology described in JP-2017-123088-A, it is not supposed to learn and predict a long-term behavior such as the “non-equidistant event” that may occur monthly. In addition, the technology described in JP-2017-123088-A does not take “extrapolation” into account.

An object of the present invention is to provide a time series data prediction apparatus and a time series data prediction method capable of predicting time series data while coping with a “non-equidistant event,” “extrapolation,” and a “base line shift.”

### SUMMARY OF THE INVENTION

A time series data prediction device according to one aspect of the present disclosure includes: an event calculation section that calculates event prediction data that is predicted values of time series data in an intended period including a past certain period on a basis of actual measured value data indicating values of the time series data in the past certain period; and a correction section that calculates, as prediction result data that is a prediction result of the time series data, data obtained by shifting each value of the event prediction data in response to a difference between the actual measured value data and the event prediction data in a same period.

According to the present invention, it is possible to predict time series data while coping with a “non-equidistant event,” “extrapolation,” and a “base line shift.”

### BRIEF DESCRIPTION OF THE DRAWINGS

FIG. 1 depicts overall configurations of an information system according to one embodiment of the present disclosure;

FIG. 2 depicts an example of hardware configurations of a management server;

FIG. 3 is an explanatory diagram of features of metric data;

FIGS. 4A to 4F are explanatory diagrams of processing performed by the management server;

FIG. 5 depicts configurations of the management server in more detail;

FIG. 6 depicts an example of a data structure of data stored in a metric DB;

FIG. 7 depicts an example of a data structure of the metric data;

FIG. 8 depicts an example of a data structure of elapsed time information;

FIG. 9 depicts an example of a data structure of a temporal feature amount;

FIG. 10 depicts an example of a data structure of a future prediction period;

FIG. 11 depicts an example of a data structure of event prediction data;

FIG. 12 is a flowchart illustrating an example operations of a future prediction section; and

FIG. 13 depicts an example of display information displayed by an analysis result display section.

### DESCRIPTION OF THE PREFERRED EMBODIMENTS

Embodiments of the present disclosure will be described hereinafter with reference to the drawings.

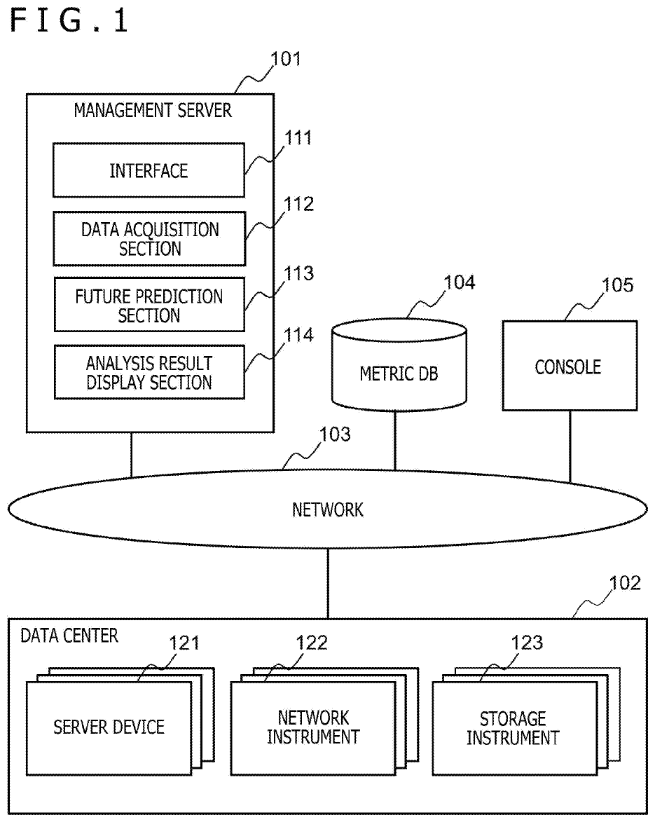

FIG. 1 depicts overall configurations of an information system according to one embodiment of the present disclosure. The information system depicted in FIG. 1 includes a management server 101, a data center 102, a network 103, a metric database (DB) 104, and a console 105.

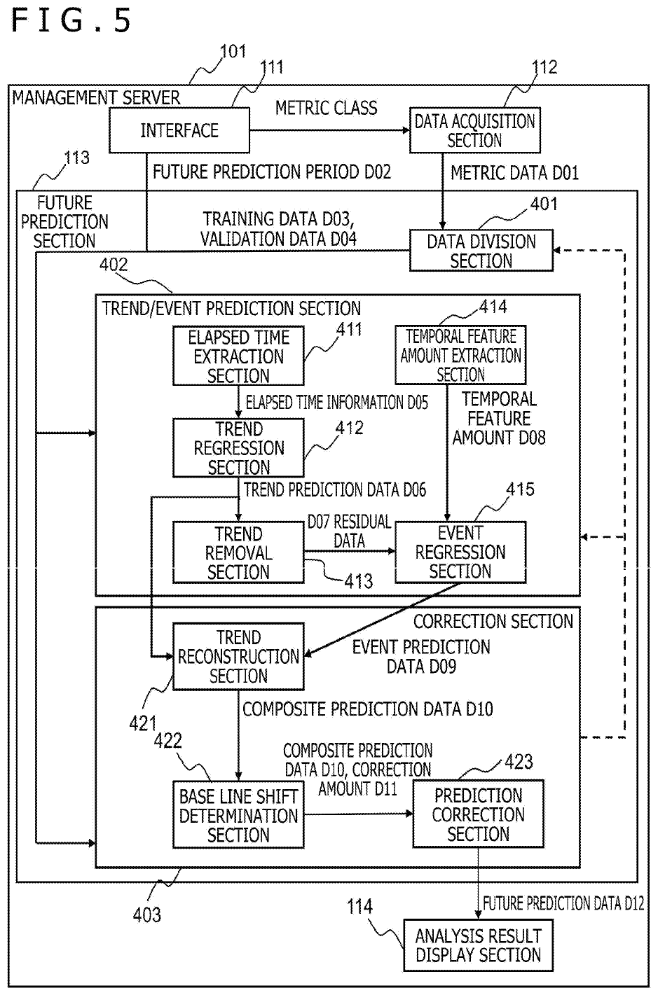

The management server 101 is a time series data prediction apparatus that predicts a future behavior of metric data that is time series data acquired from instruments to be managed installed in the data center 102. While a type of the metric data is not limited to a specific type, examples of the type of the metric data include sensing data associated with resources of the information system. The management server 101 includes an interface 111, a data acquisition section 112, a future prediction section 113, and an analysis result display section 114. Configurations of the management server 101 will be described later with reference to FIG. 5.

The data center 102 is a location where the instruments to be managed are installed. In the present embodiment, the instruments to be managed include a server instrument 121, a network instrument 122, and a storage instrument 123. The instruments to be managed may be a plurality of server instruments 121, a plurality of network instruments 122, and a plurality of storage instruments 123. Furthermore, these instruments are an example of the instruments to be managed and the instruments to be managed are not limited to these instruments.

The network 103 is a communication network that makes the management server 101, the data center 102, the metric DB 104, the console 105, and the like communicable with one another.

The metric DB 104 is a storage device that stores and manages metric data associated with the instruments to be managed.

The console 105 is an instrument used by an administrator of the information system and is an input/output device that receives various information from the administrator and that notifies the administrator of various information by displaying the information, for example.

While the management server 101, the metric DB 104, and the console 105 are disposed outside of the data center 102 in FIG. 1, the management server 101, the metric DB 104, and the console 105 may be disposed within the data center 102.

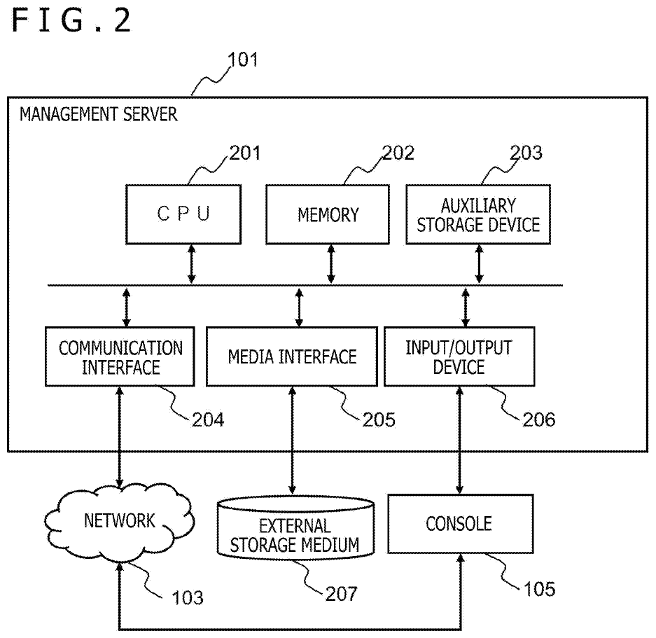

FIG. 2 depicts an example of hardware configurations of the management server 101.

In FIG. 2, the management server 101 can be realized using, for example, a commonly used computing machine. The management server 101 includes herein a central processing unit (CPU) 201, a memory 202, an auxiliary storage device 203, a communication interface 204, a media interface 205, and an input/output device 206.

The auxiliary storage device 203 is an apparatus that records data in a data writable and readable fashion, and stores a program for specifying operations of the CPU 201 and the like. The communication interface 204 communicates with an external apparatus such as the console 105 via the network 103. The media interface 205 writes and reads data to and from an external recording medium 207. The input/output device 206 is connected to the console 105 operating the management server 101.

The CPU 201 reads the program for specifying the operations of the management server 101 from the auxiliary storage device 203 to the memory 202, and executes the program using the memory 202, thereby realizing the interface 111, the data acquisition section 112, the future prediction section 113, and the analysis result display section 114 depicted in FIG. 1. It is noted that the program may be stored in the auxiliary storage device 203 in advance, acquired from the external apparatus via the communication interface 204 when needed, or acquired from the external recording medium 207 via the media interface 205. Examples of the external recording medium 207 include a hard disc, a solid state drive (SSD), an integrated circuit (IC) card, a secure digital (SD) memory card, and a digital versatile disc (DVD).

It is noted that part of or all of configurations, functions, and the like of the management server 101 may be realized by hardware by, for example, being designed with an integrated circuit.

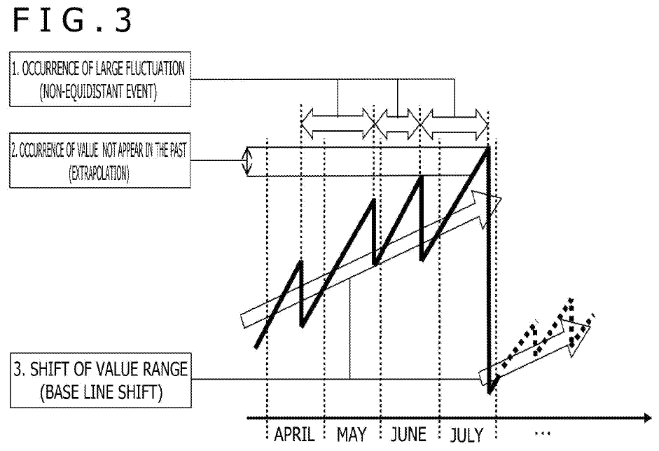

FIG. 3 is an explanatory diagram of features of metric data.

The metric data has a first feature that a “non-equidistant event” having a large fluctuation at non-equidistant timing such as a specific day of week near the end of a month often occurs. In addition, the metric data has a second feature that “extrapolation” of appearance of a value not measured in the past often occurs. It is noted that FIG. 3 depicts the “extrapolation” in July, that is, a value not measured by June. Furthermore, the metric data has a third feature that, although a relative behavior of the metric data continues before and after specific timing such as timing of a change of the month, a “base line shift” in which an absolute value range has a large shift often occurs.

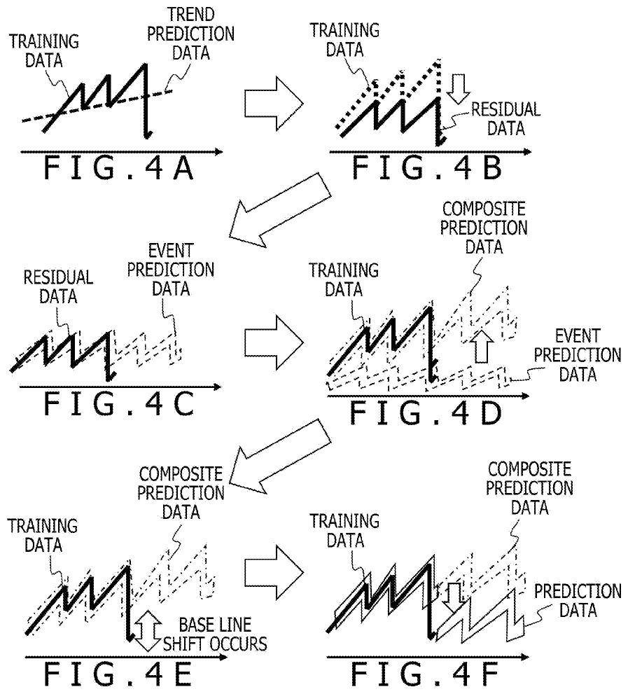

FIGS. 4A to 4F are explanatory diagrams of an outline of processing performed by the management server 101.

First, as depicted in FIG. 4A, the management server 101 performs machine learning on training data that is past metric data, learns a trend that is a tendency of a behavior of the metric data, and generates a trend prediction model. The management server 101 predicts trend data indicating the trend using the trend prediction model, and outputs the trend data as trend prediction data. The management server 101 performs trend prediction that is prediction of the trend data not only in a future period but also in a period of the training data (past period). It is noted that the trend prediction data in the past period does not necessarily accurately match the training data.

Subsequently, as depicted in FIG. 4B, the management server 101 subtracts the trend data from the training data, and generates residual data indicating relative values of the training data to the trend data. Since a part associated with “extrapolation” is removed from the training data, the residual data is data that can be handled more easily by a tree-based machine learning approach such as RANDOM FORESTS®.

Furthermore, as depicted in FIG. 4C, the management server 101 performs machine learning on the residual data, learns an event that is a behavior of the metric data exclusive of the trend, and generates an event prediction model. The management server 101 predicts event data indicating the event using the event prediction model, and outputs the event data as event prediction data. The management server 101 performs event prediction that is prediction of the event data not only in the future period but also in the period of the training data (past period).

As depicted in FIG. 4D, the management server 101 then adds the trend prediction data to the event prediction data, thereby generating composite prediction data in consideration of both of the trend and the event.

Furthermore, as depicted in FIG. 4E, the management server 101 determines whether a base line shift occurs on the basis of a difference between the training data and the composite prediction data in a terminal period of the training data. At this time, in a case of a large difference, the management server 101 determines occurrence of a base line shift.

In a case of occurrence of a base line shift, as depicted in FIG. 4F, the management server 101 shifts the composite prediction data in the future period to generate prediction data in such a manner that the composite prediction data in an initial period of the future period is closer to the data in the terminal period of the past period.

FIG. 5 depicts more detailed configurations of the management server 101. The management server 101 depicted in FIG. 5 includes the interface 111, the data acquisition section 112, the future prediction section 113, and the analysis result display section 114, as depicted in FIG. 1.

The interface 111 receives a processing request to request execution of prediction processing for predicting future values of the metric data from outside (for example, the console 105). The processing request contains, as arguments, a metric class that is a class of metric data to be predicted, and a future prediction period D02 that is a future period in which values of the metric data are to be predicted. The interface 111 outputs the metric class contained in the processing request to the data acquisition section 112, and outputs the future prediction period D02 contained in the processing request to the future prediction section 113.

The data acquisition section 112 acquires past metric data corresponding to the metric class output from the interface 111, from the metric DB 104 of FIG. 1, and outputs the past metric data to the future prediction section 113 as metric data D01.

The future prediction section 113 receives the future prediction period D02 from the interface 111 and the metric data D01 from the data acquisition section 112. The future prediction section 113 generates future prediction data D12 that is a prediction result of the metric data in the future prediction period D02 on the basis of the metric data D01, and outputs the future prediction data D12 to the analysis result display section 114.

The analysis result display section 114 displays a graphical user interface (GUI) that display information containing the future prediction data D12 from the future prediction section 113.

The future prediction section 113 will be described in more detail hereinafter. Specifically, the future prediction section 113 includes a data division section 401, a trend/event prediction section 402, and a correction section 403.

The data division section 401 extracts training data D03 and validation data D04 from the metric data D01 from the data acquisition section 112 as actual measured value data indicating values of the metric data D01 in a past certain period, and outputs the training data D03 and the validation data D04. The training data D03 is data in a period, for example, from a first month to a (T−1)-th month among the metric data D01. The validation data D04 is data in a period of, for example, a T-th month among the metric data D01. In this case, a period from a beginning of the first month to an end of the T-th month corresponds to the past certain period.

The trend/event prediction section 402 receives the future prediction period D02 from the interface 111 and the training data D03 and the validation data D04 from the data division section 401. The trend/event prediction section 402 calculates and outputs trend prediction data D06 indicating a tendency of time series data in an intended period and event prediction data D09 that is predicted values of the time series data in the intended period on the basis of the future prediction period D02, the training data D03, and the validation data D04. The intended period is a period including the certain period (the period of the training data D03 and the period of the validation data D04), more specifically, a period obtained by adding the future prediction period D02 to the certain period.

Specifically, the trend/event prediction section 402 includes an elapsed time extraction section 411, a trend regression section 412, a trend removal section 413, a temporal feature amount extraction section 414, and an event regression section 415.

The elapsed time extraction section 411 generates and outputs elapsed time information D05 indicating elapsed time on the basis of the future prediction period D02, the training data D03, and the validation data D04. The elapsed time information D05 may be information indicating elapsed time since a first point in time of the intended period (a first period of the period of the training data D03) until a last point in time of the intended period (last point in time of the future prediction period D02).

The trend regression section 412 is a trend calculation section that predicts (calculates) trend data indicating the tendency (trend) of the metric data in the intended period on the basis of the future prediction period D02, the training data D03, the validation data D04, and the elapsed time information D05, and outputs the predicted (calculated) trend data as the trend prediction data D06.

The trend removal section 413 generates and outputs residual data D07 that is relative value data indicating relative values of the training data D03 and the validation data D04 to the trend prediction data D06.

The temporal feature amount extraction section 414 generates and outputs a temporal feature amount D08 on the basis of the future prediction period D02, the training data D03, and the validation data D04. The temporal feature amount D08 is values associated with time since the first point in time of the intended period until the last point in time of the intended period, and is, for example, calendar information including months, days of week, and dates. It is noted that the calendar information may contain information such as non-work days and business days.

The event regression section 415 is an event calculation section that predicts (calculates) event data that is predicted values of the metric data in the intended period on the basis of the residual data D07 and the temporal feature amount D08, and that outputs the predicted (calculated) event data as the event prediction data D09. Since the residual data D07 is used in the present embodiment, the event prediction data D09 indicates values exclusive of a trend component of the metric data (an influence of the trend prediction data D06).

The correction section 403 calculates and outputs, as prediction result data about the metric data, the future prediction data D12 obtained by shifting each value of the event prediction data D09 from the trend/event prediction section 402 in response to a reference difference that is a difference between the actual measured value data (training data D03 and validation data D04) and the event prediction data D09. The reference difference is the difference between the actual measured value data and the event prediction data D09 in the same period.

In the present embodiment, the correction section 403 receives the validation data D04 from the data division section 401, and the trend prediction data D06 and the event prediction data D09 from the trend/event prediction section 402. Furthermore, the correction section 403 includes a trend reconstruction section 421, a base line shift determination section 422, and a prediction correction section 423.

The trend reconstruction section 421 generates and outputs, as composite prediction data D10, data obtained by shifting each value of the event prediction data D09 using the trend prediction data D06 as a reference difference. Specifically, the trend reconstruction section 421 adds up the trend prediction data D06 and the event prediction data D09, and generates an addition result as the composite prediction data D10.

The base line shift determination section 422 determines whether a base line shift occurs using the validation data D04 and the composite prediction data D10. Specifically, the base line shift determination section 422 obtains a difference between the validation data D04 and the composite prediction data D10 in a terminal period including an end of the period of the validation data D04 as the reference difference, and determines whether the reference difference is equal to or greater than a certain value. The base line shift determination section 422 determines occurrence of a base line shift in a case in which the reference difference is equal to or greater than the certain value, and determines non-occurrence of a base line shift in a case in which the reference difference is smaller than the certain value.

The base line shift determination section 422 outputs the composite prediction data D10, and further outputs a correction amount D11 in response to the reference difference that is the difference between the validation data D04 and the composite prediction data D10 in the terminal period in the case of occurrence of a base line shift. The correction amount D11 may be, for example, the same value as the reference difference or may be a value obtained by performing predetermined computing on the reference difference.

The prediction correction section 423 calculates and outputs the future prediction data D12 in response to the composite prediction data D10 and the correction amount D11. For example, the prediction correction section 423 outputs, as the future prediction data D12, data obtained by shifting each value of the composite prediction data D10 by the correction amount D11 in the case of the occurrence of a base line shift, and outputs, as the future prediction data D12, the composite prediction data D10 as it is in the case of non-occurrence of a base line shift.

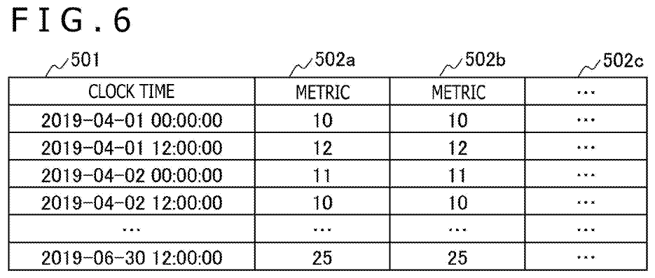

FIG. 6 depicts an example of data stored in the metric DB 104. The data stored in the metric DB 104 contains a field 501 and fields 502a to 502c. The field 501 stores a clock time of measuring (acquiring) metric data. The fields 502a to 502c store values of metric data of different classes. While a unit of the clock time is year/month/day/hour/minute/second in the present embodiment, the unit of the clock time is not limited to this example.

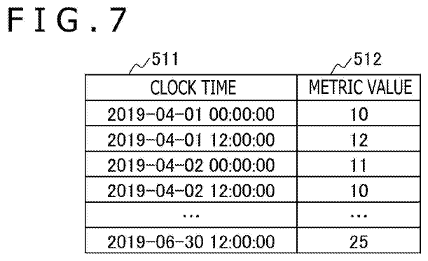

FIG. 7 depicts an example of a data structure of the metric data D01. The metric data D01 contains fields 511 and 512. The field 501 stores a clock time of measuring the metric data D01. The field 512 stores a value of the metric data D01. It is noted that data structures of the training data D03 and the validation data D04 are identical to the data structure of the metric data D01 and description thereof is, therefore, omitted.

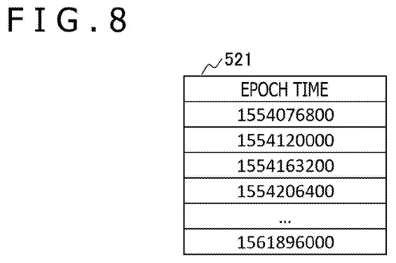

FIG. 8 depicts an example of a data structure of the elapsed time information D05. The elapsed time information DOS contains a field 521. The field 521 stores elapsed time. While epoch time is used as the elapsed time in the example of FIG. 8, the elapsed time is not limited to the epoch time.

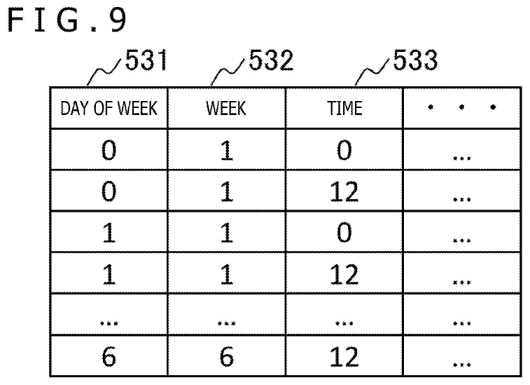

FIG. 9 depicts an example of a data structure of the temporal feature amount D08. The temporal feature amount D08 contains fields 531 to 533. The field 531 stores day-of-week information indicating a day of week. In the example of FIG. 8, the day-of-week information is any of numbers 0 to 6 indicating days of week from Sunday to Saturday. The field 532 stores week information indicating a week. In the example of FIG. 8, the week information is a serial number indicating the week with a predetermined week assumed as 1. The field 533 stores time information indicating time. The time refers herein to a value in hours (h). The temporal feature amount D08 may further contain fields storing information indicating minutes and seconds and the like.

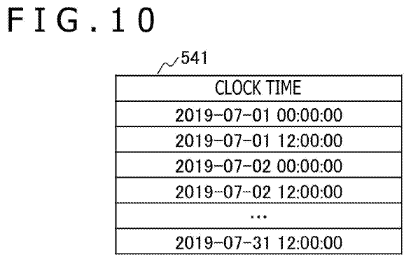

FIG. 10 depicts an example of a data structure of the future prediction period D02. The future prediction period D02 contains a field 541. The field 541 stores a clock time within the future prediction period in which the values of metric data are to be predicted.

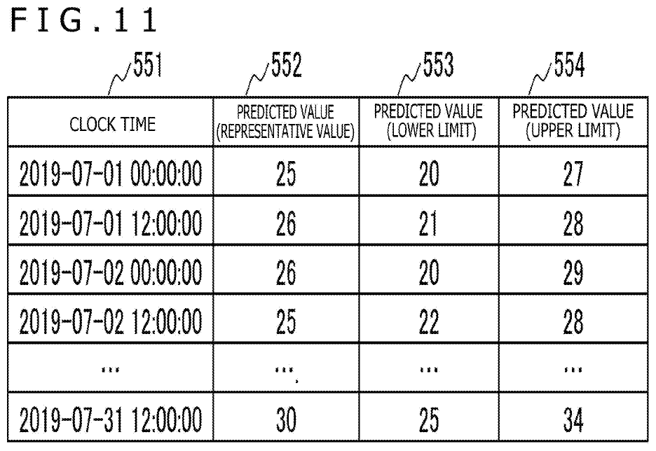

FIG. 11 depicts an example of a data structure of the event prediction data D09. The event prediction data D09 contains fields 551 to 554. The field 551 stores a clock time of predicting event data. The field 552 stores a representative value of predicted values of the event data. The field 553 stores a lower limit of the predicted values of the event data. The field 554 stores an upper limit of the predicted values of the event data. It is noted that data structures of the residual data D07, the composite prediction data D10, and the future prediction data D12 are identical to the data structure of the event prediction data D09, and description thereof is, therefore, omitted. Furthermore, a data structure of the trend prediction data D06 is a structure exclusive of the upper limit and the lower limit from the data structure of the event prediction data D09.

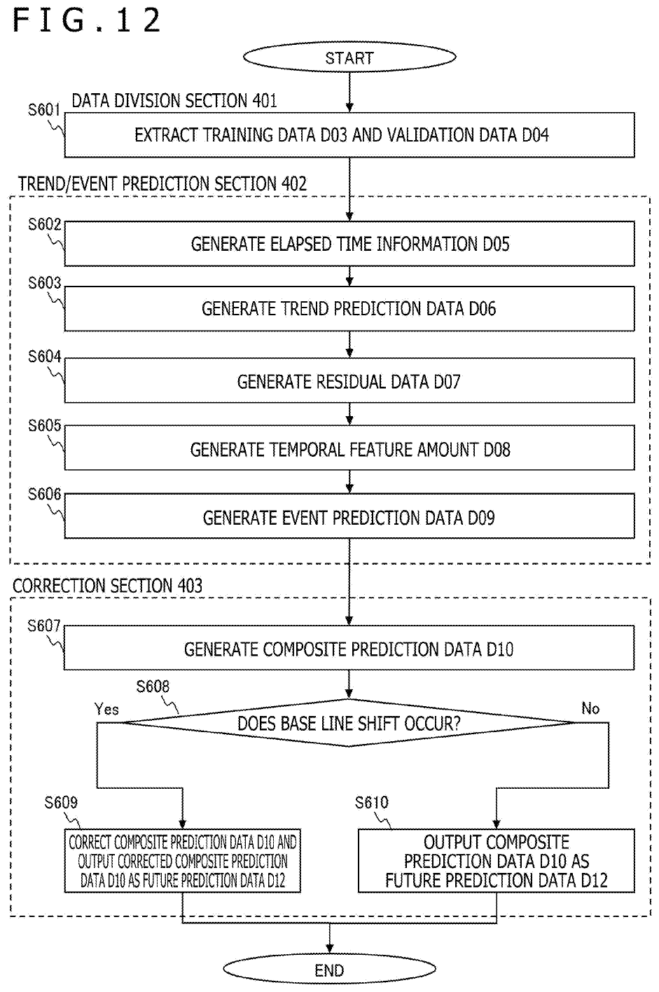

FIG. 12 is a flowchart illustrating an example of operations of the future prediction section 113. It is noted that in FIG. 12, Step S601 is processing performed by the data division section 401, Steps S602 to S606 are processing performed by the trend/event prediction section 402, and Steps S607 to S610 are processing performed by the correction section 403.

In Step S601, the data division section 401 extracts the training data D03 and the validation data D04 from the metric data D01, and outputs the training data D03 and the validation data D04. The training data D03 is data in the period, for example, from the first month to the (T−1)-th month among the metric data D01. The validation data D04 is data in the period of, for example, the T-th month among the metric data D01.

In Step S602, the elapsed time extraction section 411 generates and outputs the elapsed time information D05 on the basis of the future prediction period D02, the training data D03, and the validation data D04. It is assumed herein that the future prediction period D02 indicates a (T+1)-th month.

In Step S603, the trend regression section 412 generates a trend prediction model with the elapsed time information DOS assumed as explanatory variables and values of the trend data as objective variables on the basis of the training data D03 and the validation data D04. The trend regression section 412 calculates and outputs the trend prediction data D06 indicating the trend of the metric data in the intended period that is a period by adding up the period of the training data D03, the period of the validation data D04, and the future prediction period D02, using the trend prediction model. The trend prediction model is, for example, a linear regression model.

In Step S604, the trend removal section 413 generates and outputs the residual data D07 by subtracting the trend prediction data D06 from the actual measured value data (the training data D03 and the validation data D04). Specifically, the trend removal section 413 generates the residual data D07 by subtracting a value of the trend prediction data D06 from a value of the actual measured value data for every identical clock time.

In Step S605, the temporal feature amount extraction section 414 generates and outputs the temporal feature amount D08 on the basis of the future prediction period D02, the training data D03, and the validation data D04.

In Step S606, the event regression section 415 generates an event prediction model with the temporal feature amount D08 assumed as explanatory variables and values of the metric data as objective variables on the basis of the residual data D07. The event regression section 415 predicts metric data in the intended period using the event prediction model, and outputs the predicted metric data as the event prediction data D09.

Examples of the event prediction model include a decision tree model. In the present embodiment, the event prediction model is assumed as RANDOM FORESTS® model that is a kind of the decision tree model. In this case, the event prediction model includes a plurality of different decision trees each calculating candidate data that serves as a candidate of the event prediction data D09. The event regression section 415 calculates, as values at clock times in the event prediction data D09, a representative value, a lower limit, and an upper limit on the basis of a plurality of pieces of candidate data calculated by the decision trees. The representative value is an average value, a median value, or the like of values of each piece of candidate data. The lower limit is a 5 percentile value or the like of the values of each piece of candidate data. The upper limit is a 95 percentile value or the like of the values of each piece of candidate data.

In Step S607, the trend reconstruction section 421 adds up the trend prediction data D06 and the event prediction data D09, and outputs the addition result as the composite prediction data D10.

In Step S608, the base line shift determination section 422 determines whether a base line shift occurs by comparing a value in the terminal period of the validation data D04 with a value of the composite prediction data D10 in the same period as the terminal period.

Specifically, the base line shift determination section 422 obtains an absolute value of a difference between the value in the terminal period of the validation data D04 and the value of the composite prediction data D10 in the same period as the terminal period as the reference difference, and determines whether the reference difference is equal to or greater than the certain value. In this case, the base line shift determination section 422 determines occurrence of a base line shift in the case in which the reference difference is equal to or greater than the certain value, and determines non-occurrence of a base line shift in the case in which the reference difference is smaller than the certain value. It is noted that the terminal period of the validation data D04 may, for example, be only a terminal clock time of the validation data D04 or include a plurality of clock times including the terminal clock time. In a case in which the terminal period includes the plurality of clock times, the reference difference is an average value or the like of differences among values of the clock times included in the terminal period.

The processing of Step S609 is executed in the case of occurrence of a base line shift, and the processing of Step S610 is executed in the case of non-occurrence of a base line shift.

In Step S609, the base line shift determination section 422 calculates the correction amount D11 in response to the reference difference, and outputs the composite prediction data D10 and the correction amount D11. The prediction correction section 423 generates, as the future prediction data D12, data obtained by shifting each value of the composite prediction data D10 from the base line shift determination section 422 by the correction amount D11, outputs the future prediction data D12 to the analysis result display section 114, and ends the processing.

On the other hand, in Step S610, the base line shift determination section 422 outputs the composite prediction data D10. The prediction correction section 423 outputs, as the future prediction data D12, the composite prediction data D10 from the base line shift determination section 422 to the analysis result display section 114, and ends the processing.

The operations described so far are given as an example only and the operations are not limited to these operations. For example, as a modified embodiment, the future prediction section 113 may repeatedly calculate the composite prediction data D10 while shifting the periods of the training data D03 and the validation data D04.

For example, in Step S601, the data division section 401 assumes data in a period from the first month to an (S−1)-th month as the training data D03 among the metric data D01, and assumes an S-th month among the metric data D01 as the validation data D04. It is assumed that the future prediction period D02 is a (T+1)-th month and that S is a value equal to or smaller than T.

Furthermore, when Step S608 is over, the base line shift determination section 422 determines whether the period of the validation data D04 (S-th month) reaches a final period. The final period is specified in advance and is, for example, one month before the future prediction period D02 (T-th month).

In a case in which the period of the validation data D04 (S-th month) does not reach the final period, then the periods of the training data D03 and the validation data D04 are shifted, and the processing returns to Step S601. For example, S is incremented by 1 and the processing returns to Step S601. At this time, in a case in which occurrence of a base line shift is determined in Step S608, the trend regression section 412 generates a trend prediction model by a different approach such as a change of a period of the elapsed time used for prediction of the trend data.

The processing goes to Step S609 in a case in which the period of the validation data D04 reaches the final period and occurrence of a base line shift is determined in immediately preceding Step S608, and the processing goes to Step S610 in a case in which the period of the validation data D04 reaches the final period and non-occurrence of a base line shift is determined in immediately preceding Step S608.

It is noted that a flow of information added in a case of applying the modified embodiment described above is denoted by dotted lines in FIG. 5.

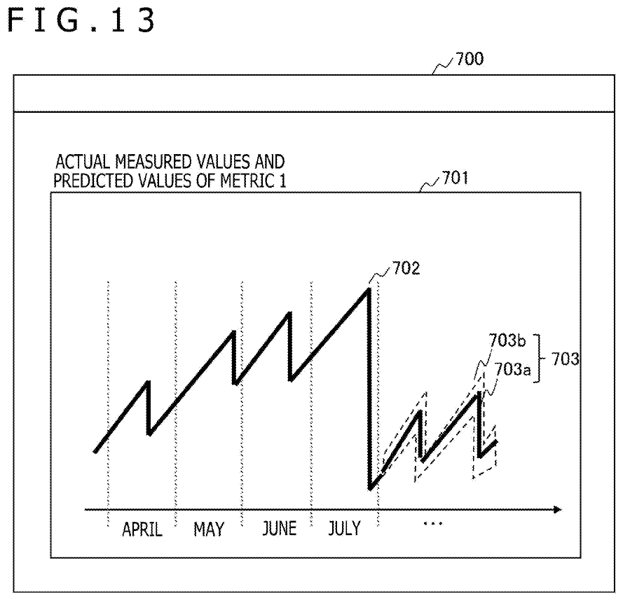

FIG. 13 depicts an example of the GUI displayed by the analysis result display section 114.

A GUI 700 depicted in FIG. 13 includes a display region 701 where the future prediction data D12 is displayed. In the display region, actual measured value data 702 indicating past values of metric data (“metric 1” in FIG. 13) in the metric class designated by the processing request received by the interface 111 and prediction data 703 that is predicted values of the metric data in the future prediction period D02 are displayed as the future prediction data D12. The prediction data 703 indicates not only representative values 703a but also a range 703b from the lower limit to the upper limit.

In the embodiments described so far, a combination of the linear regression model that is the trend prediction model and a nonlinear regression model (specifically, RANDOM FORESTS® model) that is the event prediction model is used. As the nonlinear regression model, a neural network may be used. For example, the event regression section 415 applies the training data D03 to each of N neural networks, calculates N pieces of event prediction data, and extracts K neural networks higher in prediction accuracy for the validation data D04 from those N pieces of event prediction data. The event regression section 415 calculates the event prediction data with values of each of the K neural networks assumed as explanatory variables and values of the validation data D04 assumed as objective variables in the period of the validation data D04.

As described so far, according to the present embodiments, the event regression section 415 calculates the event prediction data D09 that is predicted values of the metric data in the intended period including the past certain period on the basis of the actual measured value data (training data D03 and validation data D04) indicating values of the metric data in the past certain period. The correction section 403 calculates, as the prediction result data that is the prediction result of the time series data, the data obtained by shifting each value of the event prediction data D09 in response to the difference between the actual measured value data and the event prediction data D09 in the same period. Owing to this, each value of the event prediction data D09 is shifted in response to the difference between the actual measured value data and the event prediction data D09; thus, it is possible to appropriately predict the metric data even in a case of occurrence of the “extrapolation,” and a “base line shift.”

Furthermore, in the present embodiments, the trend regression section 412 calculates the trend prediction data D06 indicating the tendency of the metric data in the intended period on the basis of the actual measured value data. The trend removal section 413 calculates the residual data D07 that is the relative value data indicating relative values of the actual measured value data to the trend prediction data D06. The event regression section 415 calculates the event prediction data D09 on the basis of the residual data D07. The correction section 403 shifts each value of the event prediction data D09 using the trend prediction data D06 as the reference difference. Owing to this, it is possible to predict the metric data more appropriately in the case of occurrence of the “extrapolation.”

Moreover, in the present embodiments, the trend regression section 412 generates the trend prediction model with the elapsed time assumed as explanatory variables and values of the metric data assumed as objective variables on the basis of the actual measured value data, and calculates the trend prediction data D06 using the trend prediction model. The trend prediction model is, in particular, a linear regression model. In this case, it is possible to predict the tendency of the metric data in the intended period more appropriately.

Furthermore, in the present embodiments, the event regression section 415 generates the event prediction model with the calendar information assumed as explanatory variables and the values of the metric data assumed as objective variables on the basis of the residual data D07, and calculates the event prediction data D09 using the event prediction model. The event prediction model includes, in particular, a decision tree model. In this case, it is possible to predict an event component of the metric data more appropriately.

Moreover, in the present embodiments, the decision tree model includes a plurality of decision trees each calculating candidate data that serves as a candidate of the event prediction data, and the lower limit, the representative value, and the upper limit are calculated as values of the event prediction data D09 on the basis of a plurality of pieces of candidate data. In this case, it is possible to indicate a prediction range of the metric data.

Furthermore, in the present embodiments, the correction section 403 shifts each value of the event prediction data D09 in response to the difference between the validation data D04 and the composite prediction data D10 in the terminal period of the validation data D04. In this case, it is possible to predict the metric data more appropriately in the case of occurrence of the “base line shift.”

The event regression section 415 repeatedly calculates the event prediction data D09 while shifting the certain period. The trend regression section 412 changes a trend prediction data calculation method in a case in which it is determined that the reference difference is equal to or greater than the certain value. In this case, it is possible to predict the tendency of the metric data in the intended period more appropriately.

The embodiments of the present disclosure described above are exemplarily given for describing the present disclosure and not intended to limit the scope of the present disclosure only to the embodiments. A person skilled in the art can carry out the present disclosure in various other manners without departure from the scope of the present disclosure.

1. A time series data prediction apparatus comprising:
a memory for storing data;
an input/output device; and
a processor, operatively coupled to and in communication with the memory and the input/output device, the processor:
receives information from the input/output device, calculates event prediction data that is predicted values of time series data in an intended period including a past certain period on a basis of actual measured value data indicating values of the time series data in the past certain period, the data including information relating to events occurring in unequal time intervals; and
calculates, as prediction result data that is a prediction result of the time series data, data obtained by shifting each value of the event prediction data in response to a difference between the actual measured value data and the event prediction data in a same period.

2. The time series data prediction apparatus according to claim 1, wherein the processor:
calculates trend prediction data indicating a tendency of the time series data in the intended period on the basis of the actual measured value data; and
calculates relative value data indicating relative values of the actual measured value data to the trend prediction data in the certain period, wherein the processor:
calculates the event prediction data on a basis of the relative value data, and
shifts each value of the event prediction data using the trend prediction data as the difference.

3. The time series data prediction apparatus according to claim 2, wherein the processor:
generates a trend prediction model with elapsed time assumed as explanatory variables and values of the time series data assumed as objective variables on the basis of the actual measured value data, and calculates the trend prediction data using the trend prediction model.

4. The time series data prediction apparatus according to claim 3, wherein
the trend prediction model is a linear regression model.

5. The time series data prediction apparatus according to claim 2, wherein the processor:
generates an event prediction model with calendar information assumed as explanatory variables and values of the time series data assumed as objective variables on the basis of the relative value data, and calculates the event prediction data using the event prediction model.

6. The time series data prediction apparatus according to claim 5, wherein
the event prediction model includes a decision tree model.

7. The time series data prediction apparatus according to claim 6, wherein
the decision tree model includes a plurality of decision trees each calculating candidate data that serves as a candidate of the event prediction data, and
the processor calculates, as values of the event prediction data, a lower limit, a representative value, and an upper limit on a basis of a plurality of pieces of candidate data calculated by the decision trees.

8. The time series data prediction apparatus according to claim 1, wherein the processor:
shifts each value of the event prediction data in and after the certain period in response to the difference between the actual measured value data and the event prediction data in a terminal period including an end of the certain period.

9. The time series data prediction apparatus according to claim 2, wherein the processor:
repeatedly calculates the event prediction data while shifting the certain period, and
determines whether the difference between the actual measured value data and the event prediction data in the terminal period including the end of the certain period is equal to or greater than a certain value whenever the event prediction data is calculated, shifts each value of the event prediction data in response to the difference in a case in which the difference is equal to or greater than the certain value and the event prediction data is finally calculated event prediction data, and changes an approach of calculating the trend prediction data by the trend calculation section in a case in which the difference is equal to or greater than the certain value and the event prediction data is not the finally calculated event prediction data.

10. A time series data prediction method by a time series data prediction apparatus, the time series data prediction method comprising:
calculating, by a processor operatively coupled to and in communication with a memory and an input/output device, based upon information received from the input/output device, event prediction data that is predicted values of time series data in an intended period including a past certain period on a basis of actual measured value data indicating values of the time series data in the past certain period, the data including information relating to events occurring in unequal time intervals; and
calculating, by the processor, as prediction result data that is a prediction result of the time series data, data obtained by shifting each value of the event prediction data in response to a difference between the actual measured value data and the event prediction data in a same period.
